(19) United States
(12) Patent Application Publication
(10) Pub. No.: US 2014/0312085 A1
(43) Pub. Date: Oct. 23, 2014

(54) Flashlight Holster

(71) Applicant: Scott Spillane, San Diego, CA (US)

(72) Inventor: Scott Spillane, San Diego, CA (US)

(21) Appl. No.: 13/866,581

(22) Filed: Apr. 19, 2013

(51) Int. Cl. B62J 7/02

(52) U.S. Cl. CPC B62J 7/02
USPC 224/412

(57) ABSTRACT

A Flashlight Holster. The holster attaches to a front fork element of a bicycle so that a conventional large flashlight can be removably held therein. An internal O-ring located in the bottom end of the holster prevents vibration of and resists the inadvertent dislodging of the flashlight. The holster is securely attachable to the bicycle forks using a pair of conventional pipe clamps. The holster tube has a notch cut out of it so that the power switch of the flashlight can protrude therethrough when the flashlight is inserted into the holster.

This application is filed within one year of, and claims priority to Provisional Application Ser. No. 61/687,171, filed Apr. 20, 2012.

### BACKGROUND OF THE INVENTION

1. Field of the Invention

This invention relates generally to vehicle mounting accessories and, more specifically, to a Flashlight Holster.

2. Description of Related Art

Law enforcement agencies have deployed increasingly more officers on bicycles. While these bike teams are very well suited for providing a law enforcement presence in pedestrian areas, some challenges have been revealed. One particular challenge is related to the officers' ability to carry their normal tools safely and conveniently. Specifically, the standard law enforcement issued flashlight (i.e. the large type), because of its size, can truly be a challenge to carry. While a number of prior systems allow a rider to mount a lamp or light to the handlebars (to also function as a headlight), these systems all suffer from one or both of the same two problems: (1) the light is easily jostled loose from its mounting bracket, or (2) if the lamp is held securely, it is not convenient for the rider to quickly remove the flashlight from its mounting bracket. Since these full-side flashlights also double as a defensive weapon for officers, it is crucial that the officer be able to remove it easily, so it can be rapidly wielded.

### SUMMARY OF THE INVENTION

In light of the aforementioned problems associated with the prior devices, it is an object of the present invention to provide a Flashlight Holster. The holster is designed to attach to a front fork element of a bicycle so that a conventional large flashlight can be removably held therein. An internal 0-ring located in the bottom end of the holster should be included to prevent vibration and to resist the inadvertent dislodging of the flashlight. The holster should be securely attachable to the bicycle forks using a pair of conventional pipe clamps. The holster tube should further have a notch cut out of it so that the power switch of the flashlight can protrude therethrough when the flashlight is inserted into the holster.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a side perspective view of a preferred embodiment of the flashlight holster of the present invention;

FIGS. 2A-2D are photographs of the device of FIG. 1;

FIGS. 3A-3C are sequential views of the holster tube of the device of FIG. 1; and

FIGS. 4A-4C are sequential views of the mounting element of the device of FIG. 1.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Flashlight Holster.

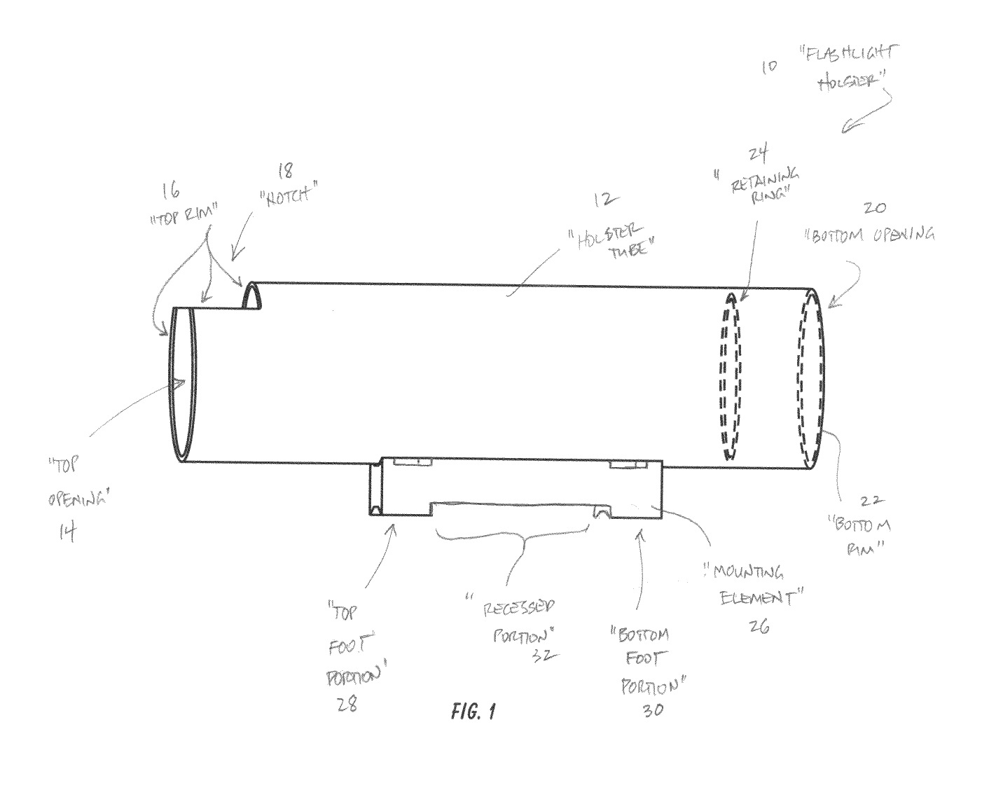

The present invention can best be understood by initial consideration of FIG. 1. ¹ FIG. 1 is a side perspective view of a preferred embodiment of the flashlight holster 10 of the present invention. The holster 10 is defined by a main holster tube 12 that terminates in a top opening 14 and a bottom opening 20. There is a notch 18 cut out of the tube 12 so that a step is created in the top rim 16 of the tube 12. The bottom opening preferably defines a circular bottom rim 22. An internal retaining ring 24 (shown in broken lines to indicate that it is located in the interior of the tube 12) is located closer to the bottom rim 22 than to the top rim 16. ¹ As used throughout this disclosure, element numbers enclosed in square brackets [ ] indicates that the referenced element is not shown in the instant drawing figure, but rather is displayed elsewhere in another drawing figure.

A mounting element 26 extends from the inner side of the tube 12 (i.e. on the side of the tube 12 that is opposite to the notch 18). The mounting element 26 is designed to cooperate with one side of the bicycle's front forks. A top foot portion 28 and bottom foot portion 30 extend outwardly from the mounting element 26. These foot portions 28, 30 are separated by recessed portion 32.

The flashlight holster 10 solves a problem faced by all law enforcement bike teams, namely how to secure a law enforcement issue flashlight while riding a bicycle. The flashlight holster 10 is compatible with the two main flashlights used by law enforcement: the Pelican and the Streamlight. The flashlight holster 10 was invented by a law enforcement officer and was tested by an actual bike team.

The flashlight holster 10 is an anodized metal tube with a metal mounting bracket and two clamps for securing it to the bicycle. Inside of the metal tube are one or two “o-rings,” one of which is Teflon; the other is rubber. The “o-rings” are essential to the purpose of the invention because they secure the flashlight in the holster while the bicycle is moving. The “o-rings” are strong enough to secure the flashlight but still allow the Officer to effectively remove the flashlight when necessary. The sizing of the metal tube is of a specific measurement to accommodate the two most popular flashlights, as named above. The bracket that is located underneath is manufactured specifically to attach the flashlight holster 10 to the front forks of a bicycle.

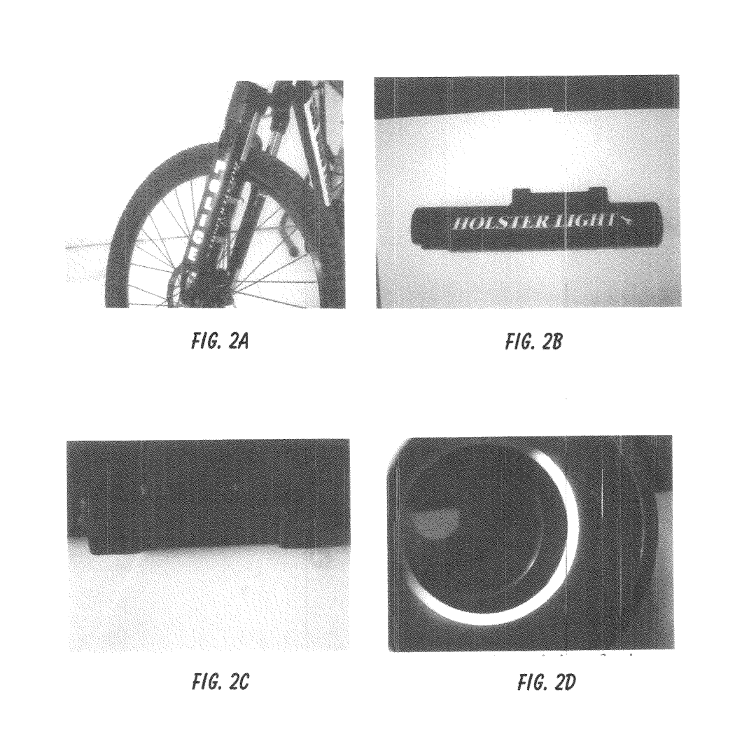

All of the components are machined into the flashlight holster 10, creating a simple design of a specific utility. FIGS. 2A-2D are four photographs depicting the Holster Light while in use. FIG. 2A shows the holster attached to the left-hand front fork of a bicycle. The holster is held to the fork by a pair of conventional pipe clamps that pass through the two clamp channels [28] and around the fork.

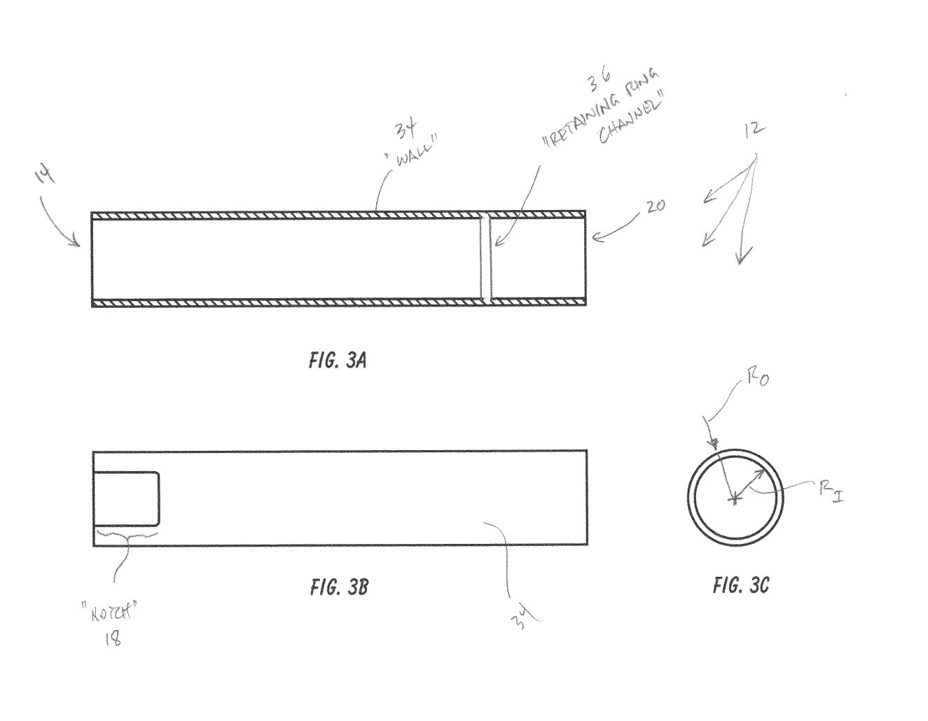

FIGS. 3A-3C are sequential views of the holster tube 12 of the device 10 of FIG. 1. The tube 12 is an elongate cylinder formed by aluminum wall 34. The tube 12 terminates in top opening 14 and bottom opening 20. At a circumferential channel 36 is cut into the wall 34 is located at a distance of preferably 1.795 inches from the bottom opening 20. As discussed previously, this channel 36 is suited to retain the Teflon retaining ring [24] within it. It may be desirable to lubricate the ring [24] with a lubricating cream or liquid so that the flashlight can easily be inserted and removed from the tube 12.

The notch 18 is cut out of the open end of the tube 12 in order to accommodate the flashlight power switch for the most popular flashlights. This allows the flashlight to fit snugly within the tube 12, and also gives the rider access to the power switch.

The preferred inner diameter RI has been determined to be 1.61 inches, and the preferred outer diameter RO has been determined to be 1.90 inches (making the wall thickness 0.29 inches).

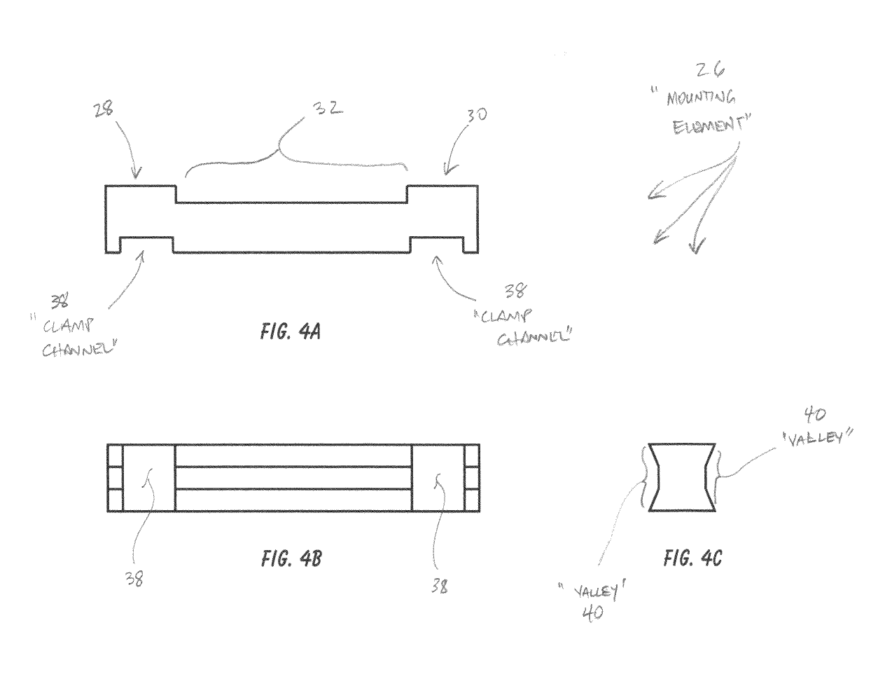

FIGS. 4A-4C are sequential views of the mounting element 26 of the device [10] of FIG. 1. There are a pair of clamp channels 38 formed in the mounting element 26, each to allow a conventional pipe clamp or other strapping element to securely attach the mounting element 26 (to which the tube [12] is attached) to the bike fork. Both sides of the mounting element 26 have valleys 40 formed along their lengths. The top and bottom feet 28, 30 have valleys 40 formed in them so that the rounded surface will conform to the outer wall of the bicycle fork. The valley 40 formed in the side facing the tube [12] will likewise conform to the rounded outer wall [34] of the tube 12.

The invention cannot effectively be constructed another way due to the specific utility of the flashlight holster 10. The specific use of “o-rings” is applicable to the flashlights used by law enforcement. A plastic model was tested and was determined not to be strong enough for this purpose. While the bracket is designed to attach to a bicycle, The flashlight holster 10 is versatile enough that it can be used on other modes of transportation (examples: Segway or all terrain vehicle).

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A holster for cylindrical devices, comprising:
a holster tube defined by an elongate cylindrically-shaped wall having an internal bore terminating at opposing ends in openings;
a flexible retaining ring located within said internal bore; and
a mounting element extending outwardly from said wall.

2. The holster of claim 1, wherein said holster tube is further defined by a bottom rim and a top rim, said bottom rim being substantially circular and said top rim being substantially circular, but further having a notch formed within it.

3. The holster of claim 2, wherein said mounting element comprises top and bottom foot portions extending outwardly therefrom.

4. The holster of claim 3, further comprising one or more clamp channels formed therein between said mounting element and said holster tube.

5. The holster of claim 4, wherein said top and bottom foot portions are defined by arcuate faces.

6. The holster of claim 5, wherein said mounting element is further defined by an arcuate face in contact with said holster tube.

7. A combination bicycle and holster, comprising:
a bicycle defined by a front wheel and a rear wheel, said front wheel attached to said bicycle by a pair of fork elements; and
a holster attached to one said fork element, said holster a seal for a container containing contents, having an inner surface and at least one opening, comprising:
a holster tube defined by an elongate cylindrically-shaped wall having an internal bore terminating at opposing ends in openings;
a flexible retaining ring located within said internal bore;
a mounting element extending outwardly from said wall; and
one or more mounting rings encircling said mounting element and one said fork element.

8. The combination of claim 7, wherein each said mounting ring passes through a channel formed between said mounting element and said holster tube.

9. The combination of claim 8, wherein said holster tube is further defined by a bottom rim and a top rim, said bottom rim being substantially circular and said top rim being substantially circular, but further having a notch formed within it.

10. The combination of claim 9, wherein said mounting element comprises top and bottom foot portions extending outwardly therefrom, said foot portions contacting said one fork element.

11. The combination of claim 10, further comprising one or more clamp channels formed therein between said mounting element and said holster tube.

12. The combination of claim 11, wherein said top and bottom foot portions are defined by arcuate faces.

13. The combination of claim 12, wherein said mounting element is further defined by an arcuate face in contact with said holster tube.

14. A flashlight holder for bicycles, comprising:
The holder of claim 14, further comprising one or more clamp channels formed therein between said mounting element and said holster tube.

15. The holder of claim 14, wherein said mounting element comprises top and bottom foot portions extending outwardly therefrom.

16. The holder of claim 15, wherein said top and bottom foot portions are defined by arcuate faces.

17. The holder of claim 16, wherein said mounting element is further defined by an arcuate face in contact with said holster tube.

18. The holder of claim 17, wherein said holster tube is further defined by a bottom rim and a top rim, said bottom rim being substantially circular and said top rim being substantially circular, but further having a notch formed within it.
